(19) United States
(12) Patent Application Publication
(10) Pub. No.: US 2024/0092340 A1
(43) Pub. Date: Mar. 21, 2024

(54) System and Method for Operating a Powertrain

(71) Applicant: Vitesco Technologies GmbH, Regensburg (DE)

(72) Inventors: Johannes Hofstetter, München (DE); Mattia Perugini, München (DE); Stefan Rohrer, München (DE); Stefan Grubwinkler, München (DE)

(73) Assignee: Vitesco Technologies GmbH, Regensburg (DE)

(21) Appl. No.: 17/767,654

(22) PCT Filed: Jul. 7, 2020
(86) PCT No.: PCT/EP2020/069136

§ 371 Date: Apr. 8, 2022

(30) Foreign Application Priority Data
Oct. 10, 2019 (DE) 10 2019 215 530.8

(51) Int. Cl. B60W 20/16; B60W 10/06; B60W 20/11

(52) U.S. Cl. CPC B60W 20/16; B60W 10/06; B60W 20/11

(57) ABSTRACT

Various teachings herein include a method of operating a vehicle comprising a combustion engine, an electric motor, and an electrically heated catalyst. The method includes: simultaneously evaluating energy consumption and emissions due to increasing or decreasing catalyst heating actions and due to increasing or decreasing electric motor torque based on an operating model; and determining an operating mode for each of the combustion engine, electric motor, and electrically heatable catalyst using the operating model to optimize operation based on an optimization goal.

### CROSS-REFERENCE TO RELATED APPLICATIONS

This application is a U.S. National Stage Application of International Application No. PCT/EP2020/069136 filed Jul. 7, 2020, which designates the United States of America, and claims priority to DE Application No. 10 2019 215 530.8 filed Oct. 10, 2019, the contents of which are hereby incorporated by reference in their entirety.

### TECHNICAL FIELD

The present disclosure relates to motor vehicles. Various embodiments of the teachings herein may include a way of operating a powertrain comprising a combustion engine, and in particular a way to implement a strategy for engine and emissions management which useful for vehicles with an electrically heatable catalyst.

### BACKGROUND

Electrification of drivetrains is important to reduce fuel consumption and to meet ever stricter pollutant emission limits. These objectives must also be achieved under real driving conditions. An improved control strategy for hybrid electrical vehicles (HEV) must take into consideration parameters related to the internal combustion engine (ICE), the electric motor (EM), and energy needed for an electrically heatable catalyst (EHC). Such a strategy should control the torque split between the combustion engine and electric motor, the power allocated to an electrically heated catalyst, etc. By doing this, the energy consumption of hybrid vehicles compared to conventional drivetrains can be reduced significantly.

Hybrid-electric vehicles (HEVs) typically comprise a traction (or high-voltage) battery which functions as an electrical energy storage and provides power to an electric drive or traction motor or machine for propulsion. Such a high-voltage battery may be at 800 v, or 400 v, or 48 v. The electric energy storage such as a battery together with the electric motor enables the recuperation of kinetic energy, the load-point adaptation of the combustion engine, torque assisting and boosting.

The hybrid configuration can also be an enabler for robust emissions management to limit emissions to within regulatory limits independent of driving conditions. For example, during low load and short distance trips, where little heat is supplied by the combustion engine, the exhaust gas temperature can be increased or augmented by heat from an electrically heatable catalyst. In the alternative, the load on the combustion engine can be increased using break torque of the electric motor. This in turn reduces the time to reach the light-off temperature of the catalytic converter, and thus increase the pollutant conversion efficiency of the catalytic converter. Thus, in anticipation of an expected decrease in temperature of a catalyst of a vehicle below a threshold, electrical power is supplied to the electrically heated catalyst. Alternatively, or concurrently, with or in anticipation of an expected decrease in temperature of a catalyst of a vehicle below a threshold, the brake torque of the electric motor can be increased.

In a high load phase, or when exhaust gas temperatures are high, a catalyst might exceed its optimal temperature range. This results in a low conversion efficiency. In such situations the load of the combustion engine can be reduced by torque support from the electric motor, which decreases the raw emission mass flow, and works to reduce the temperature of the catalytic converter. The load may be a current load, or an anticipated load based on predictive information. Thus, with or in anticipation of an expected increase in temperature of a catalyst of a vehicle above a threshold, the boost torque of the electric motor can be increased.

At all times, objectives or constraints are to provide torque demanded by the driver, keep the battery state of charge (SoC) within prescribed limits, and keep regulated emissions and anticipated regulated emissions such as NOx within regulatory limits. An operating model of the vehicle can be used to optimize the operating modes of components according to an optimization goal.

### SUMMARY

The teachings of the present disclosure include applications for systems with a combination of drive sources (electric motor EM, internal combustion engine ICE) and emissions control equipment, in particular an heatable electrically catalyst (EHC). Optimization of the different degrees of freedom of such a system can reduce fuel consumption or increase fuel efficiency, while simultaneously meeting emission limits. For example, some embodiments include a method of operating a vehicle comprising a combustion engine (120), electric motor (130), and an electrically heatable catalyst (110), comprising: simultaneously evaluating energy consumption and emissions due to increasing or decreasing catalyst heating actions and due to increasing or decreasing electric motor torque based on an operating model; and determining an operating mode for each of the combustion engine, electric motor, and electrically heatable catalyst using the operating model, such that operation is optimized according to an optimization goal.

In some embodiments, the method further includes: if deceleration is desired, simultaneously anticipated evaluating energy consumption and emissions due to increasing or decreasing catalyst heating actions and due to increasing or decreasing electric motor torque based on an operating model; and determining an operating mode for each of the combustion engine, electric motor, and electrically heatable catalyst using the operating model.

In some embodiments, the method further includes: simultaneously evaluating anticipated energy consumption and emissions due to increasing or decreasing combustion engine torque based on an operating model to determine an operating mode for each of the combustion engine, electric motor, and electrically heatable catalyst using the operating model.

In some embodiments, the evaluation uses previously learned or trained values as an operating model.

In some embodiments, the operating mode is operable to operate the electrically heatable catalyst and/or the electric motor and/or the combustion engine.

In some embodiments, in anticipation of an expected decrease in temperature of a catalyst of a vehicle below a threshold, the brake torque of the electric motor (130) is increased. 7. The method of any previous claim wherein, in anticipation of an expected decrease in temperature of a catalyst of a vehicle below a threshold, the current to an electrically heatable catalyst (110) is increased.

In some embodiments, the operating model is adapted (440) during vehicle operation.

In some embodiments, the operating modes include a vehicle speed or target speed, a target State-of-Charge (SoC) for the battery, selection of hybrid mode (e.g. recuperation, coasting), Urea or AdBlue injection time and amount, and the point in time for filter regeneration, or gear shifts and/or choice of gear.

As another example, some embodiments include a control system suited to perform the operating methods described herein, comprising an operating model which has been prepared by the steps of: simulating driving conditions; and optimizing during the simulation the use of a combustion engine (120), an electrically heatable catalyst (110) and an electric motor (130) to minimize both fuel consumption and emissions.

As another example, some embodiments include a hybrid vehicle comprising a combustion engine (120), an electrically heatable catalyst (110), an electric drive or traction motor (130), and a battery (135), wherein the vehicle is suited and adapted to perform one or more of the methods described herein.

### BRIEF DESCRIPTION OF THE DRAWINGS

FIG. 1 shows the layout of an HEV architecture including an exhaust gas aftertreatment system incorporating teachings of the present disclosure;

FIG. 2 shows a Reinforcement Learning configuration incorporating teachings of the present disclosure;

FIG. 3 shows the steps of training, testing, operating incorporating teachings of the present disclosure;

FIG. 4 shows the steps of controlling the degrees of freedom incorporating teachings of the present disclosure; and

FIG. 5 shows a SoC-dependent decision curve incorporating teachings of the present disclosure.

### DETAILED DESCRIPTION

The various control strategies discussed herein can be presented as one for the multiple degrees of freedom, which interact to influence fuel consumption and emissions: a) torque split between combustion engine and electric motor; b) electrical power to the electrically heatable catalyst; c) combustion mode of the combustion engine; d) choice of gear, gear changes; and e) comfort functions such as heating and air-conditioning. The control strategy may be implemented using different artificial intelligence techniques. One such technique is reinforcement learning (RL). The control strategy may be developed using a learning or training phase, followed by an optional test phase. A test phase may be necessary to ensure that the control strategy as trained and implemented meets mandatory emissions requirements. Learning or adjusting parameters during normal operation may or may not be possible. Through appropriate regulation of the different degrees of freedom, a control strategy can minimize both fuel consumption and emissions, with advantages as presented below.

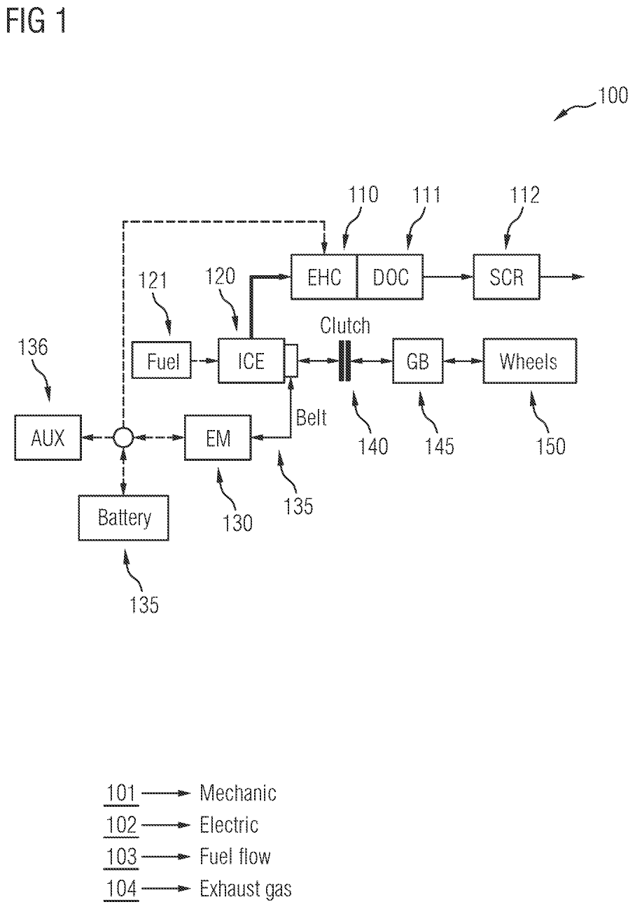

In FIG. 1 are shown the principle elements of one embodiment of a hybrid vehicle as 100. The connections are shown as mechanic 101, electric 102, fuel flow 103, and exhaust gas 104. The electrically heatable catalyst (EHC) 110 precedes the diesel oxidation catalyst (DOC) 111 in the exhaust flow. Exhaust then passes to selective catalytic reduction 112. The internal combustion engine 120 receives fuel from a fuel supply 121. The combustion engine and an electric motor 130 are mechanically connected via a belt 135 in this embodiment. Electricity to and from the electric motor 130 may pass to the battery 135, the electrically heatable catalyst 110, and other auxiliary loads shown as 136. Mechanical energy from the combustion engine and/or the electric motor pass via a clutch 140 and a gearbox 145 to the wheels 150.

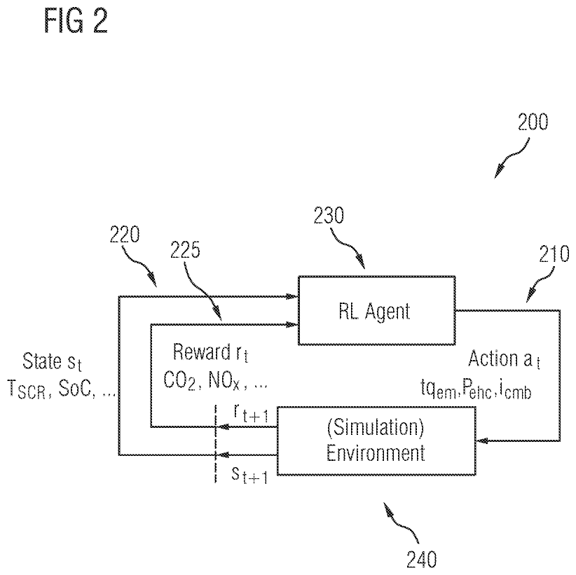

FIG. 2 shows principal elements of a reinforcement learning system 200. A reinforcement learning (RL) agent 230 provides an action vector at210 to the environment 240. The environment may be a real physical environment such as a hybrid vehicle, or it may be a simulation environment in which the principal elements of a hybrid vehicle are modeled in software. The environment takes the action vector as input and generates a resulting state vector St220 and a reward vector n 225. The action vector contains values or elements corresponding to the degrees of freedom and any additional action or control elements which are needed to operate the vehicle. For example, the action vector at may contain a value which determines how much fuel is to be supplied to the combustion engine, or how much current is to be supplied to the electrically heatable catalyst, or how much current is to be supplied by the electric motor to e.g. the battery. Other settings or controls of the operating modes which may be set in or operated by the action vector include a vehicle speed or target speed, a target State-of-Charge (SoC) for the battery, selection of hybrid mode (e.g. recuperation, coasting), Urea or AdBlue injection time and amount, and the point in time for filter regeneration (e.g. Diesel DPF regeneration), or gear shifts and/or choice of gear.

The reward vector n 225 contains information corresponding to the aspects of the environment which are to be optimized. For example, the reward vector may contain environmental values for CO2, NOx, fuel consumption, and other values relevant for environmental or emissions considerations. The state vector Stand the reward vector n return as inputs to the RL agent.

The values in the action vector will determine how the degrees of freedom are used, and the RL agent will optimize the action vector using the reward vector and the state vector. The next action vector specified by the RL agent will determine the torque split between ICE and EM, the electrical power to the EHC (in or out) and the combustion mode of the ICE. In this way, the operating model will also anticipate future fuel consumption and emissions. Thus the operating model of the vehicle is used to optimize the operating modes of components according to a chosen optimization goal, such as to minimize fuel consumption while always respecting emissions limits.

In some embodiments, other factors may also be considered in the action vector and/or state vector. For example, additional degrees of freedom may include gear shifting and gear choice, AddBlue injection, heating and cooling, etc.

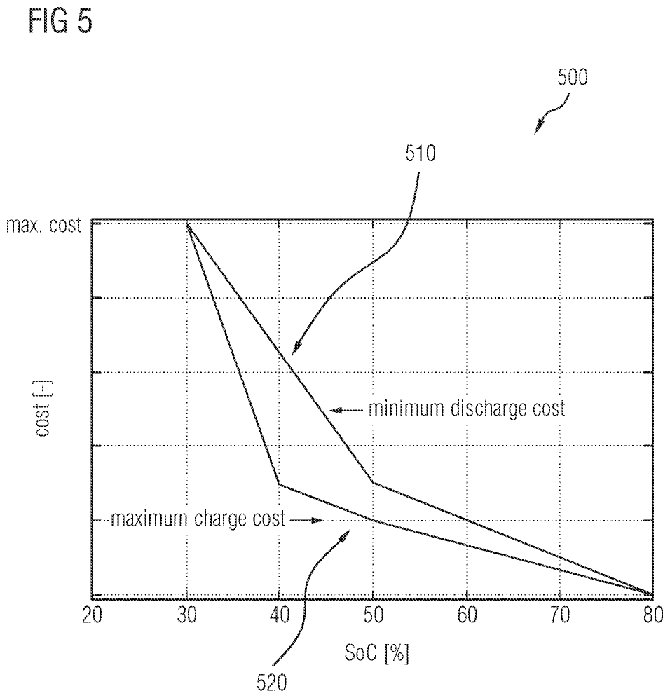

The control strategy may be implemented using a cost-based comparison of different modes of the Hybrid Electrical Vehicle. Based on a cost comparison, the strategy may decide which one of multiple modes is best for the current operating point and SoC. In one embodiment, these modes may be defined as battery charging, battery discharging and zero battery current. For each mode and operating point, costs are calculated which fulfill a mechanical power requested by the driver and a thermal constraint requested by the Aftertreatment System. The cost term is defined as the ratio of fuel power increase or decrease caused by a load point shift, and the delta of the battery power. The discharge costs can be expressed as the saved fuel power compared to depleted battery power. The charge cost, on the other hand, might be the additional fuel power used to restore battery power. Thus, the highest costs are optimal in discharge mode and the lowest costs in charge mode. By finding the lowest or the highest cost respectively, a torque setpoint and a power for the EHC can be found. During online application the hybrid mode may be selected based on a cost comparison of each mode with a cost criterion. This criterion maps the SoC to a maximum limit for the charge mode and to a minimum limit for the discharge mode as in FIG. 5. For discharge costs higher than the minimum cost, discharge is selected. For charge costs below the maximum costs, charge is selected.

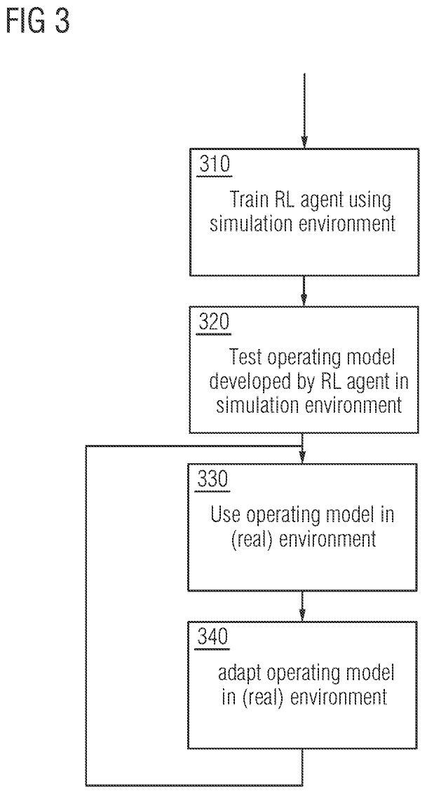

Turning to FIG. 3, the steps of training, testing, and operating are shown. In the first step 310 training is performed to find an optimal operating model. In this embodiment the operating model is determined using the loop shown in FIG. 2 and a simulated environment. Different states of operation and the resulting reward as given by the reward vector are provided to the RL agent. Various action vectors are generated, which in turn change the state of the simulated environment. The resulting reward vector is in turn evaluated by the RL agent, using the state vector as a reference.

Step 310 completes with an operating model which has been prepared by the steps of simulating driving conditions, and optimizing during the simulation the use of a combustion engine 120, an electrically heatable catalyst 110 and an electric motor 130 to minimize both fuel consumption and emissions.

When an optimal operating model has been found, this may be passed to an optional test step 320. In an embodiment with the test step, a different simulation environment is used to verify the operating model as always conforming to regulations concerning emissions conditions. For example, the simulation environment to determine the operating model may consist of a large number of simulated training trajectories, such as 500 trajectories (car trips), and a test simulation environment may consist of similar or smaller number of different verification trajectories, such as 400 trajectories (car trips). In this way, learned behavior can be verified before being used in products. Likewise, if there is a weakness in the training data, incorrect learned behavior can be identified and corrected as necessary.

The RL agent may learn to adjust the emissions profile in a way which depends on the signal to stay within regulatory limits. In particular, the EHC may be activated based on the signal. If the signal is missing in a real environment, then a vehicle using the operating model may no longer meet regulatory requirements because the EHC is not operated correctly.

Once the operating model has been found, and in certain embodiments has been tested and verified, the operating model is provided and used in a vehicle at step 330, for use in a real operating environment. In step 330, the operating model is used to provide the action vector at210 which optimizes the degrees of freedom, and which provides the control signals or operating modes needed to operate e.g. the combustion engine ICE 120, the electrically headed catalyst 110 and the electric motor EM 130. In preferred embodiments, the operating mode, as derived from the action vector at, is operable to operate the electrically heatable catalyst and/or the electric motor and/or the combustion engine. The operating mode will be set to achieve the optimization goal.

In certain embodiments, a further step 340 is possible. In step 340 the operating model is adapted to further optimize operation, for example in terms of fuel efficiency or emissions. The operating model can then be used in step 330. In other embodiments, the setpoints can be taken from a cost comparison approach.

An exhaust gas aftertreatment system (ATS) used in example vehicles may consist of an electrically heatable catalyst (EHC) 110, a Diesel oxidation catalyst (DOC) 111 and a selective catalytic reduction catalyst (SCR) 112. The main parameters of such an example HEV are given in Table 1.

TABLE 1
Example Vehicle Parameters

| | | | |
|---|---|---|---|
| Vehicle weight | M | 1523 | kg |
| ICE max. mech. Power | P_{ice, max} | 134 | kW |
| EM max. mech. Power | P_{em, max} | 30 | kW |
| EHC max. elect. Power | P_{ehc, max} | 4 | kW |
| 48 V Battery Capacity | Q₀ | 40 | Ah |

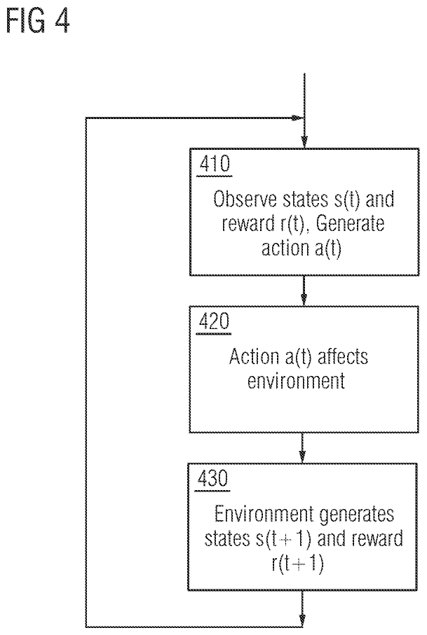

The concepts described herein can be used in a variety of vehicles with different power levels. One embodiment of the Reinforcement Learning (RL) is through the agent-environment interface as depicted in FIG. 2 using the steps of FIG. 4. In step 410 the agent observes the states Stand rewards n of the environment at a time t, then performs an action by generating an action vector at. At step 420 the environment receives and reacts to the action vector at. At a later time t+1 the environment has reacted at step 430 and generates a state vector Stand reward vector n as the environment transits into a new state. The RL agent then reads the newly generated state vector Stand reward vector n at 410 from the simulation environment and feeds the action vectors back to the model to calculate the resulting new states. The goal of the RL agent is to search for a policy to maximize the accumulated reward by the end of the learning process.

The agent weights decisions based on the current reward over the ones in the future: for a discount factor g=0, the agent goes for a greedy decision for immediate reward; with g approaching 1, the agent favors more a future reward.

There are different ways for the RL agent to develop a trial operating model. One embodiment is based on the Proximal Policy Optimization (PPO), which has shown good performance across various types of tasks. PPO is a policy gradient method, where the policy is stochastic and modeled as a parameterized probability distribution from which an action is sampled, based on the current state.

The input features for the agent and a so-called “critic” are calculated from the observations of the vehicle state. In one embodiment relevant for operating-distance-based limits, a feature is derived from the vehicle velocity v, depending on whether the traveled distance x(t) is greater or smaller than a distance such as 5 km. At the beginning of a trajectory the emissions limit is higher, and after a certain distance (e.g. 5 km) the emissions have to be lower than the defined emission limit.

Another feature is calculated as the accumulated NOx emissions compared to the traveled distance and multiplied by the NOx limit (e.g. 60 mg/km). Additional inputs are the state of charge of the battery SoC, exhaust temperature Texh and Tscr. The reward is defined proportional to the (negative) fuel mass which is proportional to the emitted CO2. If the NOx emissions exceed a limit, a penalty is added. In an embodiment the agent consists of a single linear layer neural network for P(ehc) and tq (em) control with only Tscr and SoC as inputs. For the combustion modes i (ice) a linear layer output is added to a fully connected network with leaky-relu activations and 30 neurons in a hidden layer. A tan h activation is used for the calculation of tq (em). A positive output can be scaled from 0 to the current maximum torque of the EM as tq (em, max) and a negative output is scaled from 0 to tq (em, min). Both tq (em, max) and tq (em, min) depend on SoC and are subject to derating of the EM.

In some embodiments, the output of the agent for the electrical heating is scaled to the range from zero to the maximum possible heating power P (ehc, max), limited by the SoC and the physical limit of 4 kW. The linear parts of the model are initialized with reasonable values that allow it to keep the SoC and Tscr within controllable ranges, as it is known that the SCR efficiency drops significantly towards low and high temperatures. During training the model is repeatedly evaluated on the training data. The model that fulfilled the NOx limit on all training traces and had the lowest fuel consumption among those, is selected as the final model for testing.

In FIG. 5 are shown the decision curves for optimizing costs based on the State-of-Charge SoC (500). The minimum discharge cost is shown as 510, and the maximum charge cost as 520.

What is claimed is:

1. A method of operating a vehicle comprising a combustion engine, an electric motor, and an electrically heated catalyst, the method comprising:
simultaneously evaluating energy consumption and emissions due to increasing or decreasing catalyst heating actions and due to increasing or decreasing electric motor torque based on an operating model; and
determining an operating mode for each of the combustion engine, electric motor, and electrically heated catalyst using the operating model to optimize operation based on an optimization goal.

2. The method of claim 1, further comprising:
if deceleration is desired, simultaneously evaluating anticipated energy consumption and emissions due to increasing or decreasing catalyst heating actions and due to increasing or decreasing electric motor torque based on an operating model; and
determining an operating mode for each of the combustion engine, electric motor, and electrically heated catalyst using the operating model.

3. The method of claim 1, further comprising simultaneously evaluating anticipated energy consumption and emissions due to increasing or decreasing combustion engine torque based on an operating model to determine an operating mode for each of the combustion engine, electric motor, and electrically heated catalyst using the operating model.

4. The method of claim 1, wherein evaluating anticipated energy consumption and emissions uses previously learned or trained values as an operating model.

5. The method of claim 1, wherein the operating mode defines operation of the electrically heated catalyst and/or the electric motor and/or the combustion engine.

6. The method of claim 1, further comprising, in anticipation of an expected decrease in temperature of a catalyst of a vehicle below a threshold, increasing a brake torque of the electric motor.

7. The method of claim 1, further comprising increasing a current to the electrically heated catalyst in anticipation of an expected decrease in temperature of a catalyst of a vehicle below a threshold.

8. The method of claim 1, further comprising adapting the operating model during vehicle operation.

9. The method of claim 1, wherein the operating modes include a vehicle speed or target speed, a target State-of-Charge for the battery, selection of hybrid mode, Urea or AdBlue injection time and amount, a point in time for filter regeneration, gear shifts, and/or choice of gear.

10. A control system comprising:
a memory storing set of instructions; and
a processor in communication with the memory;
wherein the set of instructions, when accessed and executed by the processor, cause the processor to:
optimize use of a combustion engine, an electrically heated catalyst, and an electric motor to minimize both fuel consumption and emissions by:
simultaneously evaluating energy consumption and emissions due to increasing decreasing catalyst heating actions and due to increasing or decreasing electric motor torque based on an operating model based on driving conditions; and
determining an operating mode for each of the combustion engine, electric motor, and electrically heated catalyst using the operating model to optimize operation based on an optimization goal.

11. A hybrid vehicle comprising:
a combustion engine;
an electrically heated catalyst;
an electric drive or traction motor;
a battery;
a memory storing a set of instructions; and
a processor in communication with the memory;
wherein the set of instructions, when accessed and executed by the processor, cause the processor to:
optimize use of a combustion engine, an electrically heated catalyst, and an electric motor to minimize both fuel consumption and emissions by:
simultaneously evaluating energy consumption and emissions due to increasing or decreasing catalyst heating actions and due to increasing or decreasing electric motor torque based on an operating model based on driving conditions; and
determining an operating mode for each of the combustion engine, electric motor, and electrically heated catalyst using the operating model to optimize operation based on an optimization goal.
